(19) United States
(12) Patent Application Publication
(10) Pub. No.: US 2009/0102725 A1
(43) Pub. Date: Apr. 23, 2009

(54) ENGAGING STRUCTURE WITH RADIATION FUNCTION IN AN OPENABLE COVER OF PORTABLE ELECTRONIC EQUIPMENT

(76) Inventor: Chia-Lun TANG, Pa-Te City (TW)

Correspondence Address: SINORICA, LLC, 528 FALLSGROVE DRIVE, ROCKVILLE, MD, 20850, US

(21) Appl. No.: 11/877,204

(22) Filed: Oct. 23, 2007

(51) Int. Cl. H01Q 1/22

(52) U.S. Cl. 343/702

(57) ABSTRACT

An engaging structure with radiation function in an openable cover of a set of portable electronic equipment. The engaging structure is mainly made of metal material, and is designed to be an antenna component with radiation function; thereby space application and design flexibilities for the antenna of the portable electronic equipment are increased at a low cost.

### BACKGROUND OF THE INVENTION

1. Field of the Invention

The present invention relates to an engaging structure of a set of portable electronic equipment, and especially to an engaging structure combined with antenna components.

2. Description of the Prior Art

Among the portable electronic equipments, for example, notebooks, PDA's or translators, are all folded structures. Basically, a set of equipment is provided with a base and an openable cover capable of folding to and opening from each other. In general, the base is a keyboard, and the openable cover is a display screen. An engaging structure is mounted on the front border of the openable cover to prevent the base and the openable cover from opening while the base is hooked in folding.

By virtue of the fast development of wireless communication, a set of portable electronic equipment has to be built in at least one antenna structure with the function of radiation for receiving signals. Because of the compactness requirement of the portable electronic equipment, the receiving space for the antenna structure has become less. Therefore, it has been the point of consideration for the art to know how to design an antenna structure without occupying too much of the inner space of the portable electronic equipment.

### SUMMARY OF THE INVENTION

In view of the problems of the abovementioned conventional technique, for a set of portable electronic equipment, the present invention provides an engaging structure with radiation function in an openable cover of a set of portable electronic equipment. The engaging structure of the portable electronic equipment is mainly made of metal material, or is made partly of metal material as well as plastic material, and this metal part is designed to be an antenna component with radiation function, thereby space application and design flexibilities for the antenna of the portable electronic equipment are increased at a low cost.

The engaging structure with radiation function in an openable cover of a set of portable electronic equipment of the present invention is designed in integration with wireless communication standards like WLAN [symbol] WWAN [symbol] WiMAX [symbol] UWB (Ultra Wideband Communication), GPS (Global Positioning System), as well as a Bluetooth antenna utilized by the portable electronic equipment (e.g. notebooks).

Moreover, in the engaging structure with radiation function in an openable cover of a set of portable electronic equipment of the present invention, the antenna component is a multi-frequency band dipole antenna structure or a monopole antenna structure.

The present invention will be apparent in the content and effects after reading the detailed description of the preferred embodiment thereof in reference to the accompanying drawings.

### BRIEF DESCRIPTION OF THE DRAWINGS

FIG. 1 is a top plan view showing an embodiment of the dipole antenna of the present invention;

FIG. 2 is a front view of the embodiment of FIG. 1;

FIG. 3 is a perspective schematic view showing the embodiment of FIG. 1 provided on a set of portable electronic equipment;

FIG. 4 shows a test result of standing wave voltage ratio (VSWR) of the embodiment of FIG. 1;

FIG. 5 is a 3D radiation field pattern view of a simulation test at 900 MHz of the embodiment of FIG. 1;

FIG. 6 is a top plan view showing the embodiment of the monopole antenna of the present invention;

FIG. 7 is a front view of the embodiment of FIG. 6;

FIG. 8 is a schematic view showing the embodiment of FIG. 6 provided on a set of portable electronic equipment;

FIG. 9 is a test result of standing wave voltage ratio (VSWR) at 900 MHz of the embodiment of FIG. 6;

FIG. 10 is a 3D radiation field pattern view of a simulation test at 900 MHz of the embodiment of FIG. 6;

FIG. 11 is a test result of standing wave voltage ratio (VSWR) at 1800 MHz of the embodiment of FIG. 6;

FIG. 12 is a 3D radiation field pattern view of a simulation test at 1800 MHz of the embodiment of FIG. 6.

### DETAILED DESCRIPTION OF THE PREFERRED EMBODIMENT

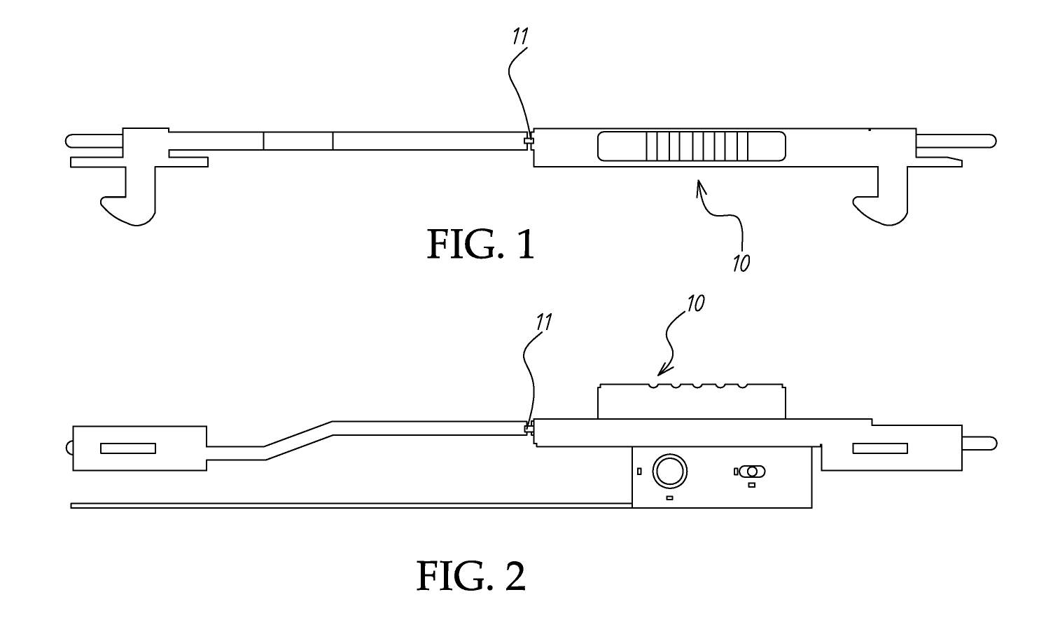

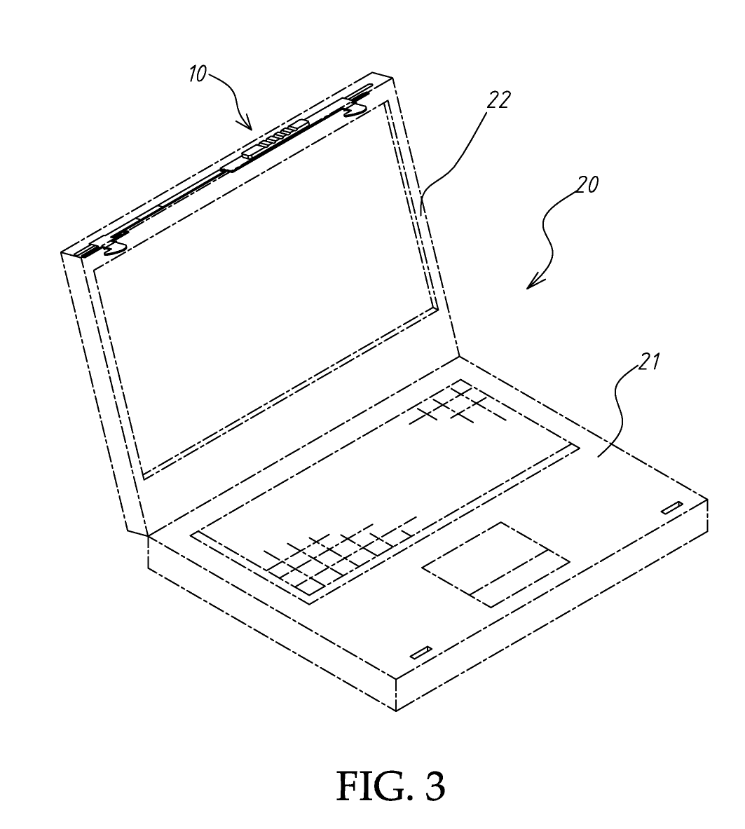

Referring to FIGS. 1-3, an engaging structure 10 of the present invention is made of metal material, and is provided in a set of portable electronic equipment 20 (for example, the notebook illustrated in FIG. 3), the portable electronic equipment 20 is provided with a base 21 folding to and opening from each other, and an openable cover 22. To prevent the base 21 and the openable cover 22 from opening, the engaging structure 10 hooks the base 21 while the openable cover 22 is folded.

The engaging structure 10 of the present invention is designed to be an antenna component with radiation function, and a signal line is connected to a feeding point 11 of it. A partial length of the metallic engaging structure 10 can be adjusted in accordance with different operating frequencies of antennas, or the engaging structure 10 stuck thereon with other metal, such as a copper foil etc., for adjusting.

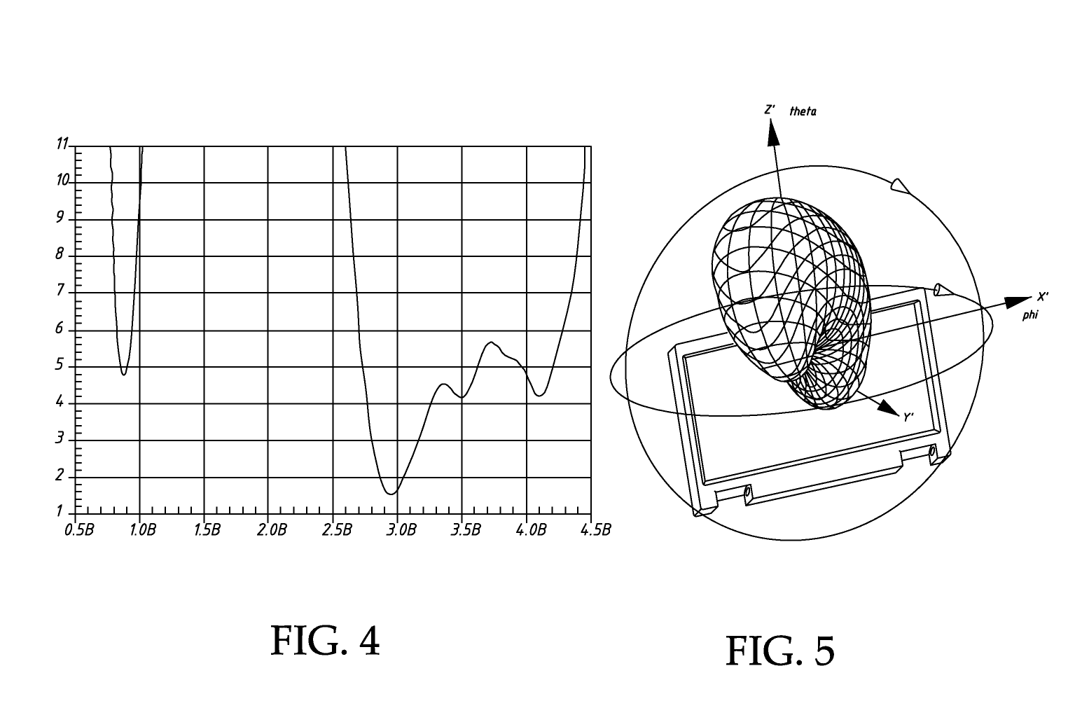

According to the embodiment shown in FIG. 1, the configuration of engaging structure 10 of the present invention is designed to be a dipole antenna structure, and can be designed in a simulation mode to be used for GSM900 band. FIGS. 4 and 5 show a VSWR pattern and a radiation field pattern of the embodiment, the test result is now listed as below:

| | | | Radiation |
|---|---|---|---|
| | Directivity(dBi) | Peak Gain(dBi) | efficiency(%) |
| 900 MHz | 4.99894 | 3.18919 | 65.9212 |

In view of the test result as listed above, the engaging structure 10 can be designed to be the excellent dipole antenna structure.

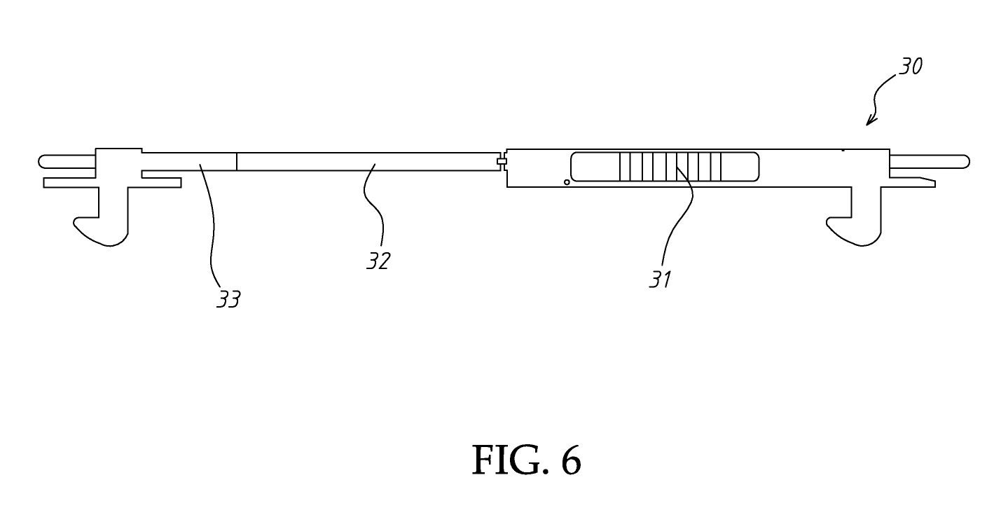

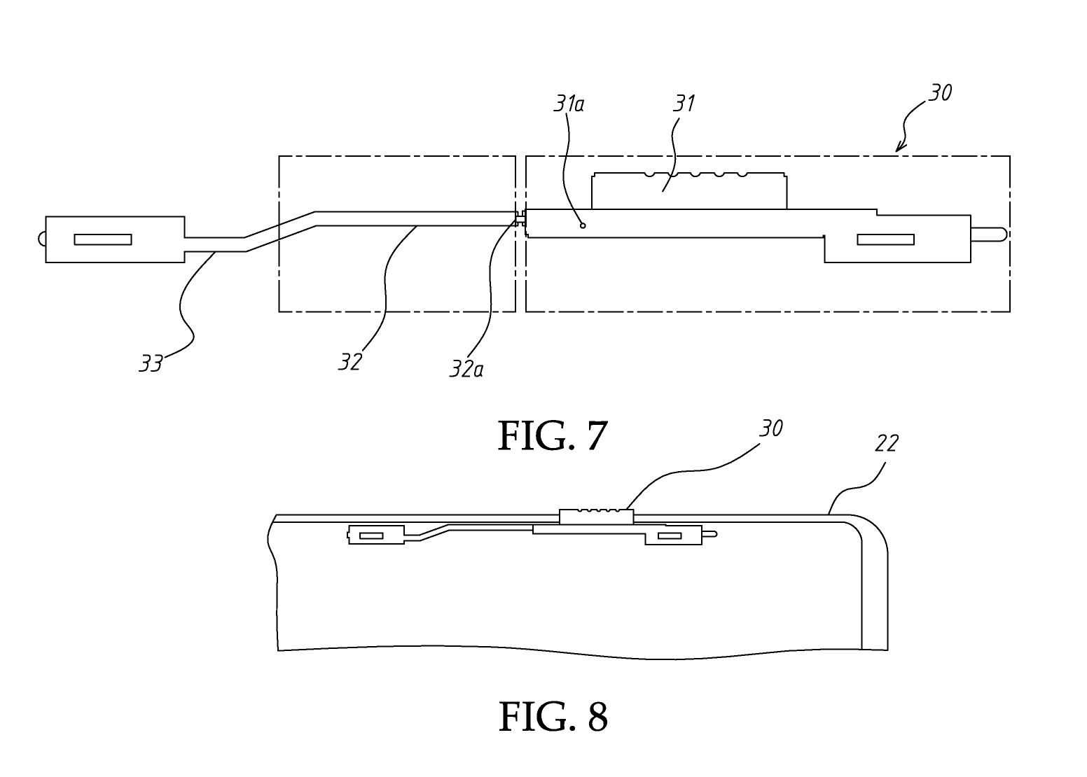

Referring to FIGS. 6 and 7, an engaging structure 30 is designed to be a dual-frequency antenna, a right half portion, 60 mm long, of the engaging structure 30 (120 mm long), is made a 900 MHz antenna 31 of metal, a feeding point 31a is provided thereon. A left middle portion, 30 mm long, of the engaging structure 30 is made a 1800 MHz antenna 32 (of metal too), and a feeding point 32a is provided thereon. The remaining left side 33 of the engaging structure 30 is made of plastic material and has no function of antenna. FIG. 8 shows the engaging structure 30 mounted on the front border of the openable cover 22 of a notebook.

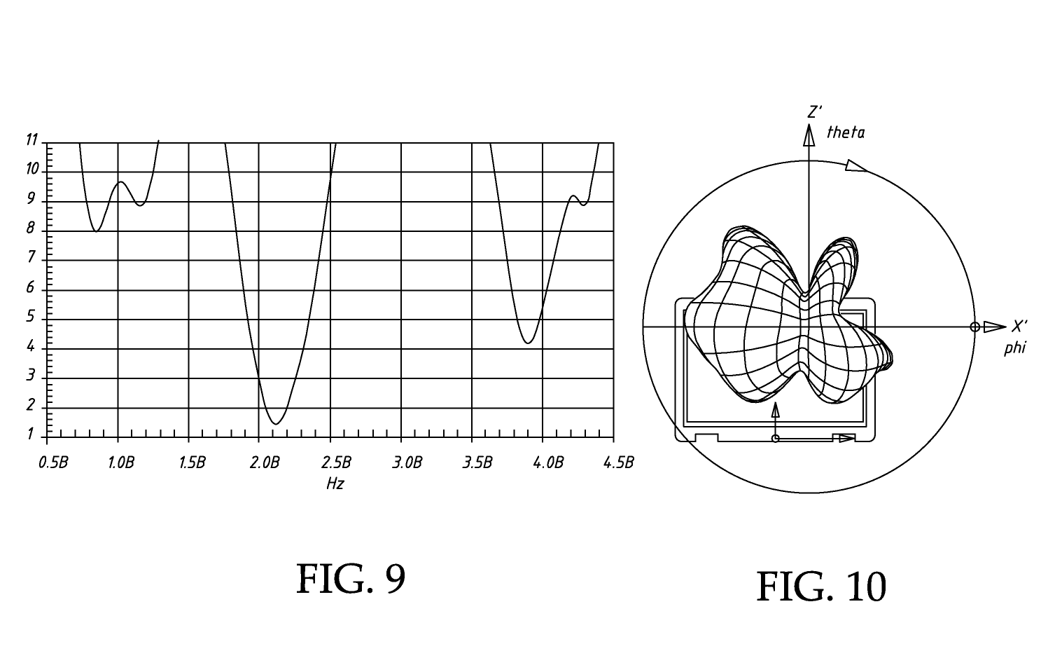

FIGS. 9 and 10 show a VSWR pattern and a radiation field pattern of the 900 MHz antenna 31, the test result is now listed as below:

| | | | Radiation |
|---|---|---|---|
| | Directivity(dBi) | Peak Gain(dBi) | efficiency(%) |
| 900 MHz | 3.88345 | 3.06796 | 82.8801 |

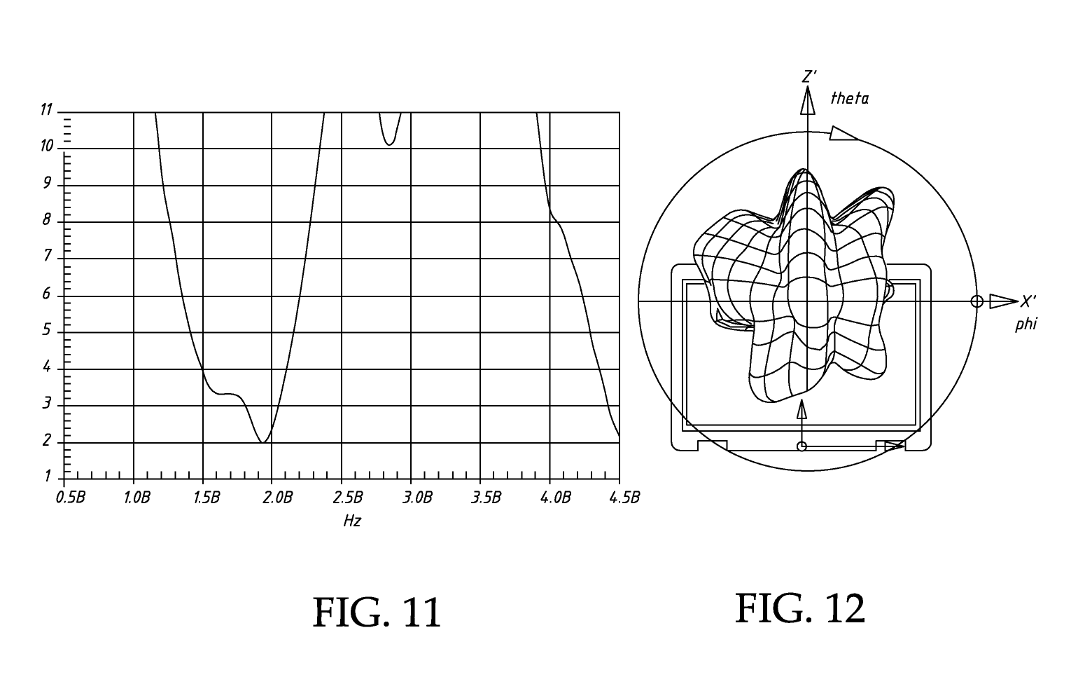

FIGS. 11 and 12 show a VSWR pattern and a radiation field pattern of the 1800 MHz antenna 32, the test result is now listed as below:

| | | | Radiation |
|---|---|---|---|
| | Directivity(dBi) | Peak Gain(dBi) | efficiency(%) |
| 900 MHz | 2.97344 | 2.58094 | 91.3588 |

In view of the test results as listed above, the engaging structure 30 can be designed to be an excellent dual-frequency monopole antenna structure. If different antenna operation bands are required, modifications can be made to the configuration of the engaging structure of the present invention, to meet such requirement in designing antennas. Thus, although embodiments of the present invention have been described in detail herein with reference to the accompany drawings, it is to be understood that the invention is not limited to them, and that various changes and modifications without departing from the spirit of the invention shall fall within the scope of the appended claims.

1. An engaging structure with radiation function in an openable cover of a set of portable electronic equipment, said portable electronic equipment is provided with a base and an openable cover for folding to and opening from each other, said engaging structure is mounted in said openable cover in order to hook the base said while said openable cover is folded; said engaging structure is characterized in: said engaging structure is made of metal material, or is made partly of metal material as well as plastic material, and configuration of said metal is designed to be an antenna component with radiation function,

2. The engaging structure with radiation function in an openable cover of a set of portable electronic equipment as in claim 1, wherein wireless communication standards utilized by said antenna component is chosen from WLAN, WWAN, WiMAX, UWB, GPS and Bluetooth.

3. The engaging structure with radiation function in an openable cover of a set of portable electronic equipment as in claim 1, wherein said antenna component is a dipole antenna structure.

4. The engaging structure with radiation function in an openable cover of a set of portable electronic equipment as in claim 1, wherein said antenna component is a monopole antenna structure.
